(19) United States
(12) Patent Application Publication
(10) Pub. No.: US 2023/0333308 A1
(43) Pub. Date: Oct. 19, 2023

(54) Systems With Window Illuminators

(71) Applicant: Apple Inc., Cupertino, CA (US)

(72) Inventors: David E. Kingman, San Francisco, CA (US); Clarisse Mazuir, San Jose, CA (US); James R. Wilson, Saratoga, CA (US); Peter F. Masschelein, Campbell, CA (US)

(21) Appl. No.: 18/337,360

(22) Filed: Jun. 19, 2023

Related U.S. Application Data
(63) Continuation of application No. 18/009,073, filed on Dec. 8, 2022, now abandoned.
(60) Provisional application No. 63/043,671, filed on Jun. 24, 2020.

(51) Int. Cl. F21V 8/00; B32B 17/06; B32B 7/12; B60Q 3/208; B60J 1/00; B60Q 3/64; B32B 27/08

(52) U.S. Cl. CPC G02B 6/0061; B32B 17/06; B32B 7/12; B60Q 3/208; B60J 1/00; G02B 6/0041; G02B 6/0043; B60Q 3/64; G02B 6/0038; B32B 27/08; B32B 2605/00; B32B 2307/418; B32B 2307/412

(57) ABSTRACT

A system may have windows. A window may have a structural window layer such as a structural window layer formed from laminated glass layers. The window may separate an exterior region from an interior region within the vehicle. A light guide illuminator in the window may provide illumination for the interior region. The light guide illuminator may have a light guide that receives light from a light source. The light guide may have a density of light scattering structures that increases as a function of increasing distance from the light source so that the interior illumination is uniform across the light guide illuminator. An adjustable optical component layer such as a light modulator and/or a haze compensation layer with a density of light scattering structures that decreases as a function of distance from the light source may be interposed between the light guide and the structural window layer.

This application is a continuation of U.S. patent application Ser. No. 18/009,073, filed Dec. 8, 2022, which is a 371 of international patent application No. PCT/US2021/036498, filed Jun. 8, 2021, which claims priority to U.S. provisional patent application No. 63/043,671, filed Jun. 24, 2020, all of which are hereby incorporated by reference herein in their entireties.

### FIELD

This relates generally to structures that pass light, and, more particularly, to windows.

### BACKGROUND

Windows are used in buildings and vehicles. Windows may be formed from glass or other transparent material.

### SUMMARY

A system such as a building may have windows. For example, a window may be mounted in a body of a vehicle to separate an exterior region surrounding the vehicle from an interior region within the vehicle.

A window may have a structural window layer such as a laminated glass layer. The laminated glass layer and other portions of the window may have a curved cross-sectional profile or other suitable shape.

The window may have a light guide illuminator that is overlapped by the structural window layer. The light guide illuminator may provide interior illumination for the interior region.

The light guide illuminator may have a light guide that receives light from a light source. The light received from the light source may be guided laterally across the window within the light guide in accordance with the principal of total internal reflection. Light scattering structures in the light guide may be used to extract some of the guided light. The extracted light serves as the interior illumination. The light guide may have a density of light scattering structures that increases as a function of increasing distance from the light source so that the interior illumination is uniform across the light guide illuminator.

One or more layers may be interposed between the light guide illuminator and the structural window layer. For example, an adjustable optical component such as a light modulator layer and/or a haze compensation layer with a density of light scattering structures that decreases as a function of distance from the light source may be interposed between the light guide and the structural window layer.

### BRIEF DESCRIPTION OF THE DRAWINGS

FIG. 1 is a schematic diagram of an illustrative system in accordance with an embodiment.

FIG. 2 is a cross-sectional side view of an illustrative light guide layer for the system of FIG. 1 in accordance with an embodiment.

FIG. 3 is a cross-sectional side view of a portion of an illustrative light guide with light-scattering structures formed from protrusions and recesses in accordance with an embodiment.

FIG. 4 is a graph showing how the density of light-scattering structures in a light guide may vary as a function of distance across the light guide in accordance with an embodiment.

FIG. 5 is a graph showing how the intensity of illumination extracted from an illustrative light guide may be constant as a function of distance across the light guide in accordance with an embodiment.

FIG. 6 is a top view of an illustrative light guide showing how light-scattering structures may be distributed to create stripes of emitted light in accordance with an embodiment.

FIG. 7 is a top view of an illustrative light guide showing how light-scattering structures may be distributed to illuminate an area with the shape of an icon or other desired shape in accordance with an embodiment.

FIG. 8 is a cross-sectional side view of an illustrative light guide with a transparent substrate layer covered with a light extraction layer in accordance with an embodiment.

FIG. 9 is a cross-sectional side view of an illustrative window structure having a light guide overlapped by an adjustable optical component such as an adjustable light modulator layer in accordance with an embodiment.

FIG. 10 is a cross-sectional side view of an illustrative window structure having a light guide with non-uniformly distributed light-scattering structures and a compensation layer with a complementary haze pattern in accordance with an embodiment.

FIG. 11 is a cross-sectional side view of an illustrative window structure having a light guide with a light-scattering layer and an associated haze compensation layer with a transparent substrate covered with a layer of light scattering structures in accordance with an embodiment.

FIG. 12 is a cross-sectional side view of an illustrative light guide layer with mating tapered portions in accordance with an embodiment.

FIG. 13 is a cross-sectional side view of an illustrative window structure with a light guide and an air gap in accordance with an embodiment.

FIGS. 14 and 15 are cross-sectional side views of illustrative window structures with light guides, adjustable tint layers, and no air gaps in accordance with an embodiment.

FIG. 16 is a top view of an illustrative light guide with a stepwise varying density of light scattering structures in accordance with an embodiment.

FIG. 17 is a cross-sectional side view of an illustrative light guide with a stepwise varying density of light scattering structures in accordance with an embodiment.

### DETAILED DESCRIPTION

A system may have a window that includes a light guide illuminator. The light guide illuminator may emit light that serves as illumination for nearby objects.

The system in which the window is used may be a building, a vehicle, or other suitable system. Illustrative configurations in which the system is a vehicle may sometimes be described herein as an example. This is merely illustrative. Window structures may be formed in any suitable systems.

The light guide illuminator may be formed from one or more layers of transparent material forming a light guide (light guide layer) that extends across the window. A light source may provide light to one or more edges of the light guide. Light from the light source that is emitted into the light guide may travel laterally across the light guide in accordance with the principal of total internal reflection. Light-scattering structures in the light guide may be used to extract the guided light from within the light guide.

Light that is extracted from the light guide may propagate outwardly away from the surface of the light guide. This emitted light from the light guide may serve as illumination. For example, this emitted light may serve as interior illumination for a vehicle in which the window is formed.

Electrically adjustable components in the window may be used to adjust the characteristics of the window. For example, the light guide illuminator may be adjusted to control the amount of interior illumination that is provided. The window may also include one or more additional layers such as an electrically adjustable light modulator layer (sometimes referred to as an adjustable tint layer), an adjustable reflectivity mirror layer, and/or other electrically adjustable optical devices.

An adjustable light modulator in the window may be adjusted between transparent and opaque states. In the transparent state, a vehicle occupant in the interior of a vehicle can view the environment surrounding the vehicle through the window. In the opaque state, privacy is enhanced because people surrounding the vehicle will not be able to view occupants in the vehicle interior through the window. The adjustable light modulator may overlap the light guide illuminator. When the light guide illuminator is being used to provide interior lighting, the adjustable light modulator may be placed in the opaque state to prevent light from the light guide illuminator from being emitted outwardly from the window.

When the environment surrounding the vehicle is sunny, the adjustable light modulator layer may serve as an electrically adjustable sunroof for a rooftop window or may be used to implement an electrically adjustable shade for a side, front, or rear window. The adjustable light modulator layer may use any suitable adjustable optical layer(s). In an illustrative configuration, the adjustable light modulator may be a device such as an adjustable liquid crystal light modulator (e.g., a guest-host liquid crystal light modulator) with an adjustable level of light transmission. If desired, the adjustable light modulator may be an electrically adjustable mirror layer (e.g., a cholesteric liquid crystal device that provides an electrically adjustable light transmission and an electrically adjustable mirror reflectivity).

In general, adjustable layers in the window may include layers with globally and/or locally adjustable optical properties such as adjustable transparency, adjustable reflectivity, adjustable light absorption, adjustable light emission, adjustable haze, and/or other adjustable properties. Adjustable optical components for windows may sometimes be referred to as adjustable optical layers, adjustable window layers, adjustable components, adjustable optical component layers, etc.

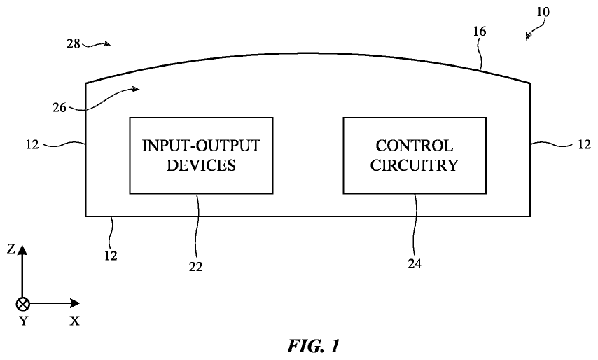

An illustrative system of the type that may include windows is shown in FIG. 1. System 10 may be a vehicle, building, or other type of system. In an illustrative configuration, system 10 is a vehicle. As shown in FIG. 1, system 10 may have support structures such as body (vehicle body) 12. Body 12 may include doors, trunk structures, a hood, side body panels, a roof, and/or other body structures. System 10 may include a chassis to which wheels are mounted, propulsion and steering systems, and other vehicle systems. Seats may be formed in the interior of body 12. Window 16 and portions of body 12 may separate interior 26 of vehicle 10 from the exterior environment (exterior 28) that is surrounding vehicle 10.

Windows such as window 16 may be formed in body 12. The windows in system 10 such as window 16 may include a front window on the front of a vehicle, a moon roof (sun roof) window or other window extending over some or all of the top of a vehicle, a rear window at the rear of a vehicle, and/or side windows on the sides of a vehicle. Illustrative configurations in which window 16 is formed over the top of a vehicle (e.g., facing upwards towards the exterior region surrounding the vehicle in vertical direction Z in the example of FIG. 1) may sometimes be described herein as an example. Window 16 may be flat (e.g., window 16 may lie in the X-Y plane of FIG. 1) or window 16 may have one or more curved portions (e.g., window 16 may have a curved cross-sectional profile and may be oriented to lie generally parallel to the X-Y plane so that a convex surface of window 16 faces outwardly in direction Z as shown in FIG. 1).

System 10 may include control circuitry 24 and input-output devices 22. Control circuitry 24 may include one or more processors (e.g., microprocessors, microcontrollers, application-specific integrated circuits, etc.) and storage (e.g., volatile and/or non-volatile memory).

Input-output devices 22 may include displays, sensors, buttons, light-emitting diodes and other light-emitting devices, haptic devices, speakers, and/or other devices for gathering environmental measurements and/or user input. The sensors in devices 22 may include ambient light sensors, touch sensors, force sensors, proximity sensors, optical sensors, capacitive sensors, resistive sensors, ultrasonic sensors, microphones, three-dimensional and/or two-dimensional images sensors, radio-frequency sensors, and/or other sensors. Output devices in input-output devices 22 may be used to provide a user with haptic output, audio output, visual output (e.g., displayed content, light, etc.), and/or other suitable output.

During operation, control circuitry 24 may gather information from sensors and/or other input-output devices 22 such as ambient light measurements and/or other sensor data, user input such as voice commands provided to a microphone, a touch command supplied to a touch sensor, button input supplied to one or more buttons, etc.). Control circuitry 24 may use this input in controlling the operation of one or more electrically adjustable components in window 16. for example, control circuitry 24 may adjust the amount of illumination supplied by a light guide illuminator, may adjust the light transmission and/or other optical characteristic(s) of an adjustable light modulator, and/or may make other adjustments to window 16 based on user input, ambient light measurements, other sensor data, and/or other information gathered using input-output devices 22.

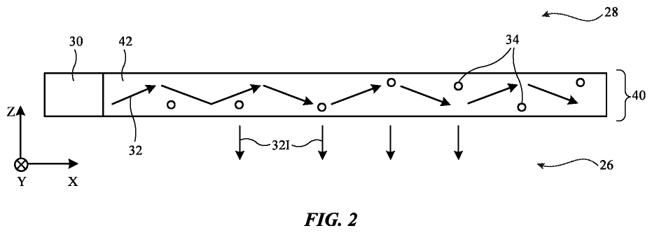

Window 16 may be formed from one or more layers of transparent glass, clear polymer (e.g., polycarbonate), polymer adhesive layers, and/or other layers. Window 16 may use an electrically adjustable light guide illuminator to provide illumination for interior 26. An illustrative light guide illuminator for a window such as window 16 of FIG. 1 is shown in FIG. 2. As shown in FIG. 2, light guide illuminator 40 may have a light source such as light source 30 that is configured to emit light into the edge of a light guide such as light guide (light guide layer) 42. In the example of FIG. 2, light is being emitted into the left edge of light guide 42. If desired, light may be emitted into an opposing right edge of light guide 42 in addition to being emitted into the left edge of the light guide, may be emitted into all four edges of a rectangular light guide, and/or may otherwise be coupled into light guide 42. Illustrative configurations in which light is emitted into a single edge of a light guide are sometimes described herein as an example.

Light source 30 of FIG. 2 may include one or more light-emitting diodes, lasers (e.g., laser diodes), and/or other sources of light. The light produced by light source 30 may be visible light and/or may include light at infrared and/or ultraviolet wavelengths. Light guide 42 may be formed from one or more planar transparent layers and/or transparent layers with curved cross-sectional profiles. In an illustrative configuration, light guide 42 is formed from a substrate layer of glass or polymer. Arrangements in which light guide 42 has a substrate covered with one or more additional light guiding layers may be used, if desired. In window 16, a higher-refractive-index layer such as light guide 42 may be sandwiched between a pair of opposing lower-refractive-index cladding layers or may otherwise be configured to promote light guiding.

The footprint (outline when viewed from above) of light guide 42 may be rectangular and/or may have other suitable shapes (e.g., a shape with curved and/or straight sides, an elongated strip shape, an oval shape, a rectangular shape with rounded corners, etc.). If desired, light source 30 may include multiple light-emitting devices that extend in an array along the edge of light guide 42 (e.g., into the page of FIG. 2).

Light 32 that is emitted into the edge of light guide 42 from light source 30 is guided internally in light guide 42 in accordance with the principal of total internal reflection. This distributes light 32 laterally in the X-Y plane. For example, light from light guide 30 on the left edge of light guide 42 of FIG. 2 may be guided in the X direction across light guide 42 toward the opposing right edge of light guide 42.

Light 32 that is being guided by light guide 42 may be extracted from light guide 42 to serve as interior illumination 321 for system 10 using light scattering structures 34. Light scattering structures 34 may be structures formed on and/or embedded in light guide 42 that are characterized by a refractive index value (or values) different from the refractive index of the material making up light guide 42. Light scattering structures 34 may include voids, air bubbles, and/or cavities that are filled with other gases, particles of gel, polymer, glass, inorganic materials (e.g., metal oxide particles such as particles of titanium oxide, zirconium oxide, aluminum oxide, etc.), polymer particles, and/or other light scattering structures. When light 32 strikes structures 34, light 32 is directed out of light guide 42 (e.g., this light is extracted from light guide 42). The extracted light includes light that travels out of the lower surface of waveguide 42 in the −Z direction of FIG. 2. This extracted light may serve as illumination 321 for interior region 26. Some extracted light may also be emitted in the +Z direction.

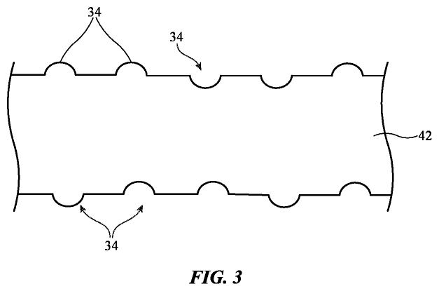

As shown in FIG. 3, light guide 42 may, if desired, include light scattering structures 34 such as protrusions (bumps and/or ridges) and recesses (pits and/or grooves). Light scattering structures such as protrusions and/or recesses may be formed on one or both sides of light guide 42 and may optionally be used in a light guide that incorporates embedded light scattering structures such as the light scattering structures of FIG. 2. Any suitable technique may be used for forming light scattering structures 34 (e.g., embedding structures during extrusion of light guide layers, during co-extrusion of light guide layers with other layers in window 16, during molding of light guide 42, by ink jet printing of a light scattering patterned layer, by surface texturing using techniques such as molding, machining, stamping, etching, laser processing, etc.), and/or other techniques. If desired, a dark peripheral border layer (e.g., a black ink layer) may be printed on one or more layers in window 16 around the peripheral edge of window 16 at the same time or in a separate step from printing operations used in forming light scattering structures 34. In some configurations, light scattering particles, protrusions, depressions, and/or other light scattering features may have sizes greater than about 150 nm or other suitable sizes and/or shapes to help reduce wavelength dependency of the light scattering process and thereby ensure color uniformity.

Light 32 that is emitted into light guide 42 by light source 30 is guided within light guide 42. Guided light 32 in light guide 42 travels in the +X direction of FIG. 2. Because light 321 is being extracted from light guide 42, the intensity of light 32 at any given point within waveguide 42 decreases as a function of increasing distance along the X direction. As a result, the intensity of illumination 321 could potentially decrease as a function of distance X. If desired, the density of light scattering structures 34 can be varied as a function of position within light guide 42. For example, to compensate for light intensity falloff due to the decrease of light intensity in light guide 42 with increasing distance X, the density of light scattering structures 34 can be increased by a compensating amount.

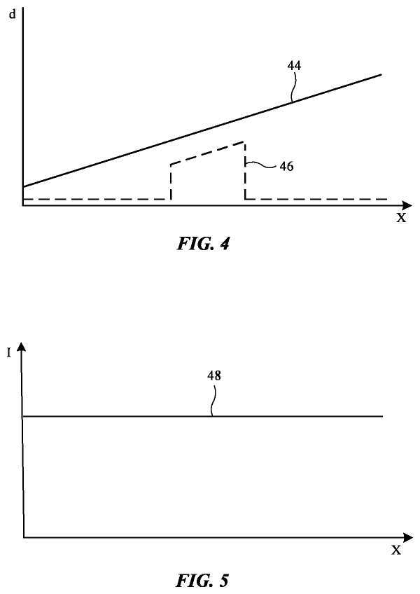

As shown in FIG. 4, for example, density d of light scattering structures 34 may, if desired, be increased as a function of distance X in accordance with curve 44 (or other continuously or stepwise increasing function) to compensate for the decrease in the intensity of light 32 within light guide 42 as a function of distance X. As a result of this compensating density gradient, light scattering structures 34 can extract illumination 321 that is uniform across the lateral dimensions (X, Y) of light guide illuminator 40 (e.g., the intensity I of the light extracted from light guide 42 may be constant as a function of distance X as shown by curve 48 of FIG. 5 (e.g., within a tolerance of 10%, 5%, 2%, 1% or other suitable tolerance).

In general, light scattering structures 34 may be formed in light guide 42 with any suitable density (e.g., a constant and therefore uniform density, a gradually increasing density with increasing distance from light source 30 to compensate for light fall off in light guide 42 as a function of increasing distance from light source 30, etc.). In the example of curve 46 of FIG. 4, the density d of light scattering structures 34 is low except in a particular area in the middle of light guide layer 42. In this region, light scattering structures 34 are present (and have an increasing density). With this illustrative configuration, uniform illumination 321 may be emitted from an isolated area in the middle of light guide 42 (e.g., a logo-shaped area as an example).

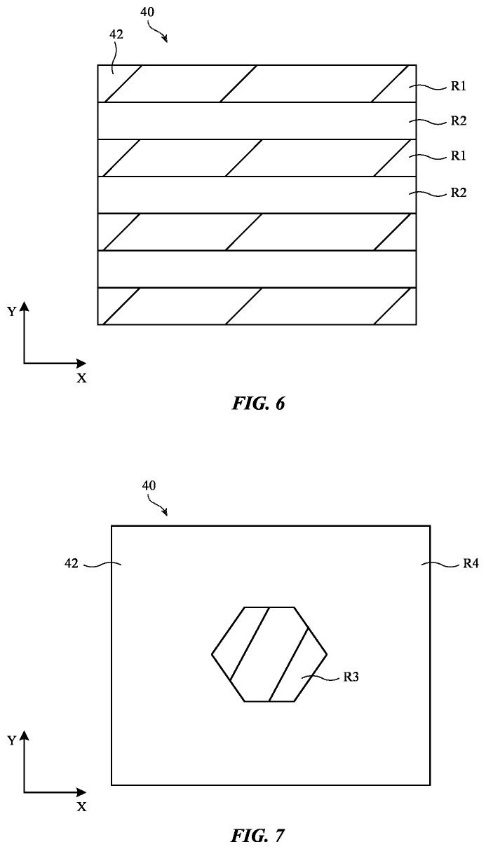

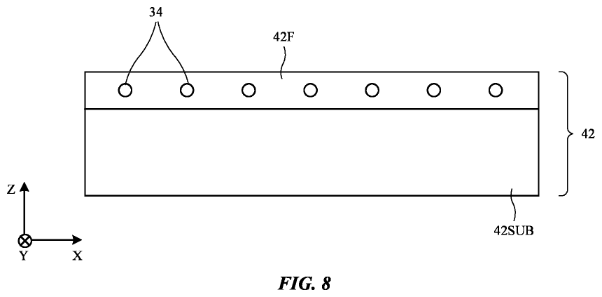

Other patterns of interior illumination 321 may be produced by light guide illuminator 40, if desired. FIG. 6 is a top (bottom) view of illuminator 40 showing how light scattering structures 34 may be distributed within light guide 42 so that light guide illuminator 40 emits illumination 321 in elongated strip-shaped regions R1 but does not emit any illumination 321 in interleaved elongated strip shaped regions R2 (which are free of light scattering structures in this example). In the illustrative configuration of FIG. 7, illuminator 40 is configured to emit illumination 321 in region R3 but not in region R4 (or vice versa). Light guide 42 of FIG. 7 may, as an example, have a density d of light scattering structures 34 of the type shown by curve 46 of FIG. 4. Region R3 may be an abstract pattern, may correspond to the shape of a logo or text, etc.

If desired, light extracting structures 34 may be formed in a coating or laminated film that is separate from other layer(s) in light guide 42. This type of arrangement is shown in FIG. 8. As shown in the example of FIG. 8, light guide 42 may include a transparent light guide layer such as layer 42SUB. Layer 42SUB may be formed from clear polymer, transparent glass, a layer that is planar and/or a layer with a curved cross-sectional profile, etc. and may sometimes be referred to as a light guide substrate layer or light guide substrate. Layer 42F, which may sometimes be referred to as a light extraction layer, may be formed from a coating (e.g. a polymer coating deposited on the surface of layer 42SUB), an optical film (e.g., a polymer film that is attached to the surface of layer 42SUB by an interposed layer of adhesive), and/or other layer attached to layer 42SUB. Layer 42F may contain light extraction structures 34 to extract light. The index of refraction of layer 42F may be equal to that of layer 42SUB or may have another suitable value that allows light that is traveling in light guide layer 42SUB to enter layer 42F and interact with light scattering structures 34. Light scattering structures 34 may be provided in layers on the upper and/or lower surfaces of layer 42SUB and/or may be provided in layer 42SUB.

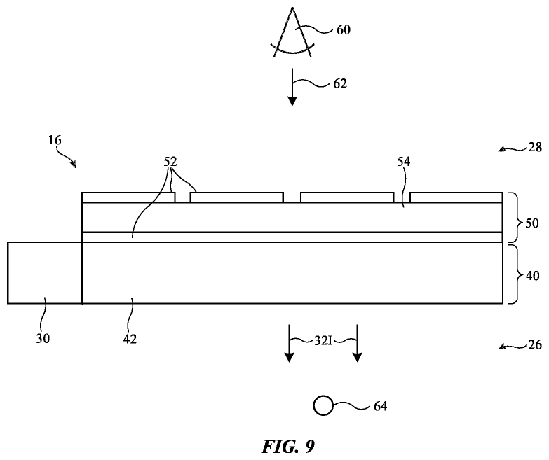

Window 16 may include one or more adjustable optical layers that overlap some or all of light guide illuminator 40 and light guide 42. As shown in FIG. 9, for example, window 16 may include one or more adjustable optical layers such as adjustable optical layer 50. Layer 50 may have electrodes such as electrodes 52 and one or more interposed layers such as layer 54. Electrodes 52 may receive control signals (e.g., voltages) from control circuitry 24. Transparent conductive material such as indium tin oxide may be used in forming electrodes 52, so that light may pass through layer 50 and window 16. Electrodes 52 may be pixelated to provide control circuitry 24 with the ability to display various patterns on window 16 (e.g., to display images, text, decorative patterns, flashing regions, etc.). In some illustrative configurations, there is only a single globally addressed electrode 52 on the upper surface of adjustable optical layer 50 and a corresponding single globally addressed electrode 52 on the opposing lower surface of adjustable optical layer 50. Layer 54 may include adjustable optical structures (e.g., layer 54 may be a liquid crystal layer such as a guest-host liquid crystal layer with a light transmission that is adjusted in response to the signals from control circuitry 24 or a cholesteric liquid crystal layer that changes light absorption and reflectivity as a function of control signals from circuitry 24. Other types of electrically adjustable structures may be included in layer 54 if desired.

In arrangements in which layer 50 exhibits adjustable light transmission, layer 50 may sometimes be referred to as an electrically adjustable light modulator or light modulator layer. A light modulator (e.g., layer 50) may be placed in a first state (e.g., a transparent state in which a first amount of light is transmitted through layer 50 such as at least 70%, at least 90%, at least 95%, less than 99%, etc.) and a second state (e.g., an opaque state in which a second amount of light is transmitted through layer 50 that is less than the first amount (e.g., less than 30%, less than 10%, less than 5%, at least 1%, etc.). Light modulator layers may also be adjusted to exhibit intermediate amounts of light transmission. In cholesteric liquid crystal devices, the amount of mirror reflectivity exhibited by layer 50 (as well as its associated light transmission) may likewise be varied between lower and higher values (and optionally may be set to intermediate values). In general, layer 50 may exhibit adjustable amounts of color, light transmission, light reflection, light absorption, haze, and/or other optical properties. The foregoing examples are illustrative.

As shown in FIG. 9, layer 50 may be attached to light guide 42 (e.g., with a layer of adhesive) so that some or all of layer 50 overlaps light guide 42. During operation, control circuitry 24 may (in response to sensor data and/or user input) issue control signals to light source 30 of light guide illuminator 40 to adjust the amount of light emitted by light source 30 and thereby control the amount of illumination 321 that is emitted by light guide illuminator 40. To prevent light leakage from window 16 while illumination 321 is being emitted, control circuitry 24 may place layer 50 in an opaque state (or other reduced light transmission state) whenever illumination 321 is being produced (or whenever illumination 321 over a given intensity is being produced). This shields a viewer such as viewer 60 who is viewing window 16 in direction 62 from stray illumination 321, as well as blocking the ability of viewer 60 to view people or other elements in interior 26 such as interior element 64.

In addition to serving as light extraction features for light guide 42, light scattering structures 34 create haze for transmitted light (e.g. light passing from interior 26 to exterior 28 for viewing by an external viewer and ambient light passing from exterior 28 to interior 26, which can be observed by the occupants of system 10). In configurations in which the density of light scattering structures 34 has a gradient (see, e.g., curve 44 of FIG. 4), window 16 may exhibit a haze gradient. To counteract this effect and thereby make the haze of window 16 uniform across the surface of window 16, a haze compensation layer (sometimes referred to as a haze gradient compensation layer or haze non-uniformity compensation layer) may be incorporated into window 16.

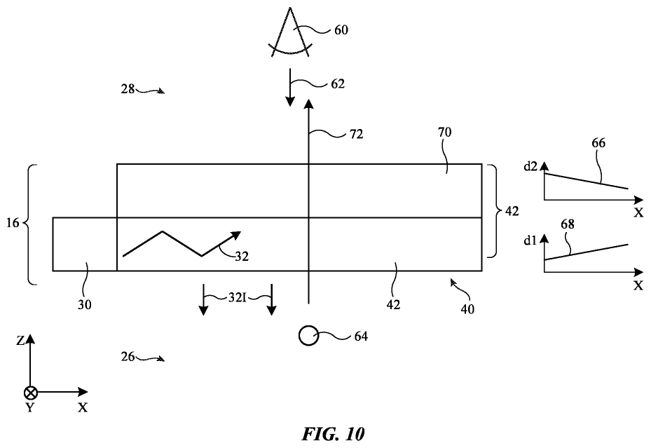

Consider, as an example, window 16 of FIG. 10. As shown in FIG. 10, window 16 may include light guide illuminator 40. Illuminator 40 may have light source 30 for emitting light 32 into light guide 42. Light guide 42 may have light scattering structures 34 with a non-uniform density across light guide 42. The density of light scattering structures 34 may, as an example, increase as a function of distance X from light source 30 as shown by illustrative light scattering structure density d1 of curve 68 in the lower graph of FIG. 10.

The gradient in the density of light scattering structures 34 in light guide 42 helps ensure that illumination 321 will be uniform (in this example). When external viewer 60 views interior element 64 in direction 62, image light 72 from element 64 is transmitted through window 16. Due to the gradient in the density of light scattering structures 34 in light guide 42, the amount of haze imparted to light 72 by light guide layer 42 will increase across light guide 42 (e.g., haze will increase as a function of increasing position along dimension X). To counteract this uneven haze contribution from light guide 42, window 16 may include one or more layers that impose a counteracting amount of haze.

As shown in FIG. 10, for example, a haze non-uniformity compensation layer such as haze compensation layer 70 may overlap light guide 42. In areas of window 16 where the haze of light guide 42 is low (e.g., in areas of window 16 near light source 30), the haze of layer 70 may be relatively high to compensate. In areas of window 16 where the haze of light guide 42 is high due to the presence of a relatively large density of light scattering structures 34 (e.g., near the right-hand edge of light guide 42 of FIG. 10), the haze of layer 70 may be correspondingly low. Layer 70 may, as an example, have light scattering structures 34 that have a decreasing density d2 as a function of increasing distance X (see, e.g., curve 66 in the upper graph of FIG. 10). The refractive index of layer 70 may be lower than the refractive index of light guide 42 to help ensure that light 32 is guided within light guide 42 in accordance with the principal of total internal reflection rather than entering layer 70 and being scattered by the light scattering structure of layer 70. If desired, an intervening low-index layer (e.g., an air gap, a low-index polymer layer, other cladding structures, etc.) may be interposed between layer 70 and light guide 42 rather than attaching layer 70 to the upper surface of light guide 42. The configuration of FIG. 10 illustrative.

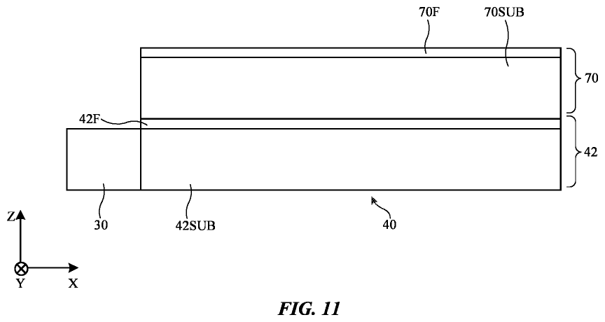

In the illustrative configuration of FIG. 11, window 16 includes a light guide illuminator formed from a light extraction layer (light scattering layer) such as layer 42F on a substrate layer 42SUB (e.g., a light guide substrate with or without light scattering structures). Window 16 of FIG. 11 also includes a haze compensation layer formed from at least two sublayers. In particular, haze compensation layer 70 of FIG. 11 includes a transparent substrate layer 70SUB formed from a low-haze polymer or glass layer without light scattering structures 34 and includes an overlapping light extraction coating or film (e.g., a polymer film attached to layer 7SUB with an interposed layer of adhesive) such as light extraction layer 70F on the surface of layer 70SUB. Light extraction layer 70F may have a density of light scattering structures that is complementary to the density of light scattering structures 34 in light guide 42 (e.g., in layer 42F). As described in connection with FIG. 10, this complementary density of light scattering structures allows layer 70 to compensate for haze non-uniformity due to the uneven lateral distribution of light scattering structures 34 in light guide 42. Layer 70 may have a lower index of refraction than light guide 42 to help ensure that light 32 is confined to light guide 42 and does not pass through layer 70.

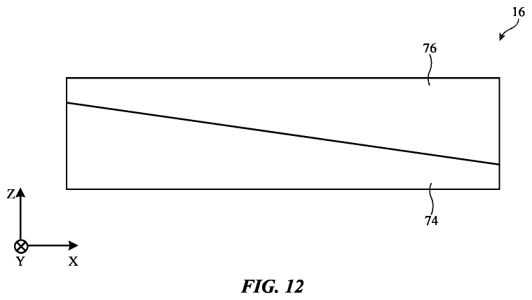

If desired, window 16 may include one or more layers of complementary tapered thickness as shown by lower layer 74 and upper layer 76 of window 16 of FIG. 12. Layers 74 and 76 may, for example, form a light guide and may respectively serve as a transparent light guide substrate layer and an associated light extraction layer with light scattering structures for the light guide. In another illustrative arrangement, one of layers 74 and 76 may be a light guide (with one or more layers) and another of layers 74 and 76 may be a haze compensation layer having a complementary density of light scattering structures to help create a uniform haze for light transmitted through window 16.

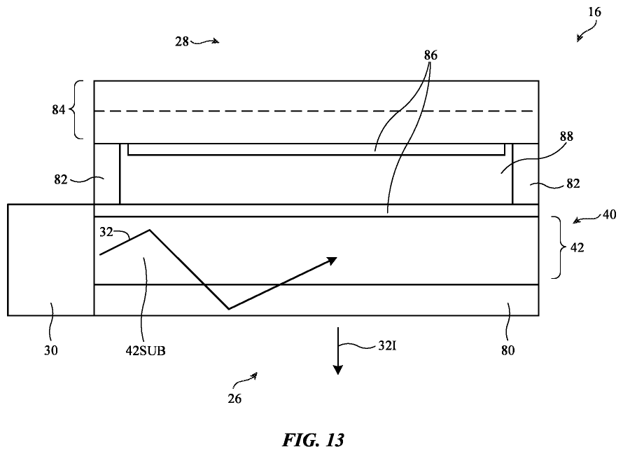

FIG. 13 is a cross-sectional side view of an illustrative configuration for window 16 in which window 16 has an air gap. As shown in FIG. 13, light guide illuminator 40 includes light source 30 for emitting light into light guide 42. Light guide 42 includes light scattering structures to extract light from light guide 42 and thereby create illumination 321. Light guide 42 may be formed from a transparent material such as clear glass or polymer. As an example, light guide 42 may have a clear substrate layer such as layer 42SUB that is formed from a clear polymer such as acrylic.

To help protect light guide 42 from scratches, the inner surface of layer 42SUB may be covered with a protective inner layer such as cover glass layer 80. In the illustrative example of FIG. 13, the refractive index of layer 80 is matched (within 00.15, 0.1, 0.05, or other suitable amount) to the refractive index of layer 42SUB to allow light 32 to pass from layer 42SUB to layer 80 without experiencing internal reflections and the interface between layer 42SUB and layer 80. In this type of configuration, protective layer 80 forms part of light guide 42. Spacer structures 82 (e.g., a glue bead the extends around the peripheral edge of light guide 42) may separate outer window layer 84 from light guide 42 so that air gap 88 is present between outer window layer 84 and light guide 42. Optional antireflection coating layers 86 may be formed on the inwardly facing surface of layer 84 and light guide substrate layer 42SUB to help suppress undesired stray light reflections.

Window layer 84 and/or other layers in window 16 may serve as structural window layers that help support and strengthen window 16. Layers such as layer 84 may be formed from one or more layers of transparent glass, clear polymer (e.g., polycarbonate), polymer adhesive layers, and/or other layers. These layers may be strengthened (e.g., by annealing, tempering, and/or chemical strengthening). In some arrangements, layer 84 may include only a single structural layer (e.g., a layer of glass having a thickness of 3-6 mm or other suitable thickness for providing window 16 with sufficient structural support to allow window 16 to be used in a vehicle). In other arrangements, two or more layers of structural glass may be used in forming layer 84.

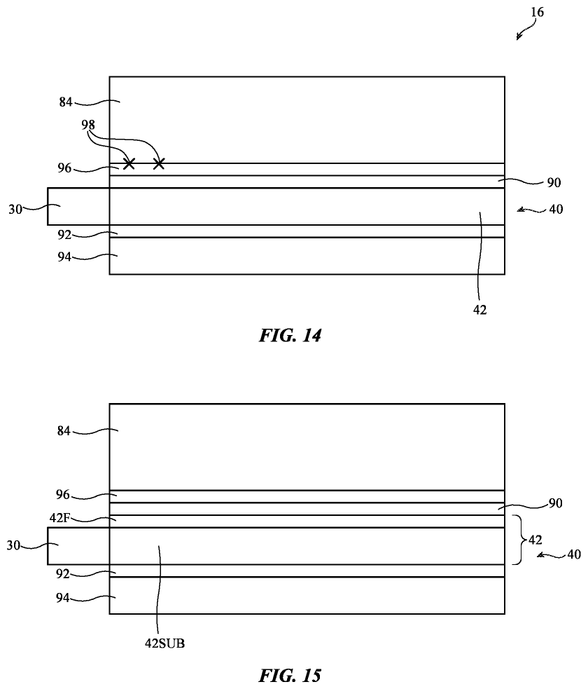

In the example of FIG. 13, the lowermost surface of light guide 42 is directly exposed to interior 26, so this surface is exposed and may be touched by the fingers of a vehicle occupant. To prevent directly contact with light guide 42 and thereby avoid a risk that fingerprints on the lower surface of light guide 42 will create undesired light-scattering regions, the lower surface of light guide 42 may be covered with one or more cladding layers. This type of arrangement is shown in FIG. 14. In the FIG. 14 configuration, light source 30 provides light to light guide 42. Light guide 42 may include light scattering structures with a density gradient configured to ensure that extracted light is emitted uniformly. One or more layers with a lower refractive index than light guide 42 may be placed below (and, if desired, above) light guide 42. For example, cladding layer 90 may be placed above light guide 42 and cladding layer 92 may be placed below light guide 42. Layers 90 and 92 may be formed from cured liquid adhesive, polymer films, and/or other transparent materials with a lower refractive index than the material of light guide 42 (e.g., polymer, glass, etc.). An additional protective layer (sometimes referred to as a cover layer) such as layer 94 may be attached below layer 92 (e.g., using additional adhesive or the adhesive of layer 92). The refractive index of layer 94 may be lower than the refractive index of light guide 42 to promote light guiding in light guide 42 and/or cladding functions for light guide 42 may be provided by cladding layer 92. Layer 94 may be formed from polymer, glass, or other clear material.

One or more layers may be interposed between outer window layer 84 and layer 90 such as illustrative layer(s) 96. These layers may include haze compensation layers such as layer 70, fixed optical layers, adjustable optical layers, pixelated layers, layers that are globally adjusted, etc. In an illustrative configuration, layer 96 of window 16 of FIG. 15 may be an electrically adjustable optical component such as electrically adjustable layer 50 of FIG. 9 (e.g., an adjustable mirror layer, an adjustable light modulator layer, etc.). The layers of window 16 of FIG. 15 may be laminated together so that window 16 of FIG. 15 is free of air gaps. One or more layers of adhesive may be incorporated into window 16 to attach respective pairs of adjacent overlapping layers in window 16 of FIG. 15 together. In system 10, window 16 may be coupled to body 12.

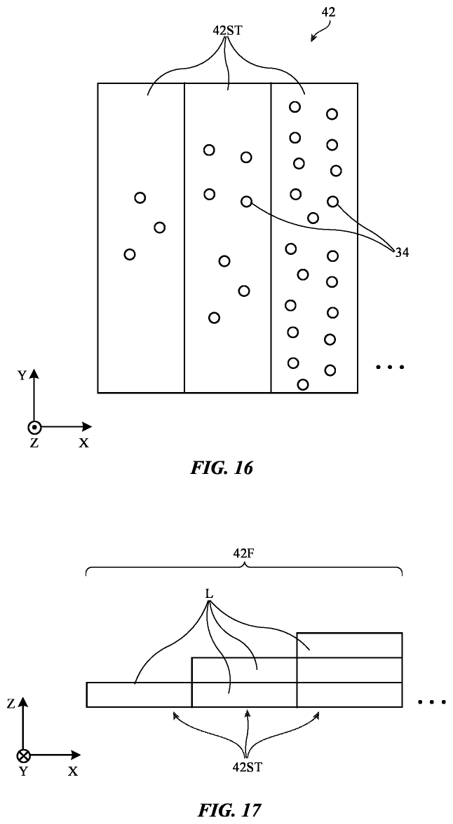

If desired, the density of light scattering structures 34 in light guide 42 (and/or in a haze compensation layer overlapping light guide 42) may vary in a stepwise fashion (e.g., the density for structures 34 as a function of distance across light guide layer 42 away from light source 30 may exhibit stepwise changes). As shown in FIG. 16, the density of light scattering structures 34 may be different in each of a series of parallel strip-shaped regions 42ST that extend laterally across light guide 42 in a direction perpendicular to the main direction of light propagation (which is along the X axis in the example of FIG. 16). With this type of arrangement, the density of light scattering structures increases (in a stepwise fashion) as a function of increasing lateral distance X across light guide 42 (e.g., as a function of increasing distance from light source 30).

Light scattering structures 34 may be embedded in a light guide substrate layer and/or may be formed in a film or coating such as layer 42F that is attached to the surface of a light guide substrate. In the illustrative configuration of FIG. 17, a stepwise increase in the density of light-scattering structures in layer 42F has been provided by providing layer 42F with stacked layers L of light-scattering material (e.g., polymer film with embedded light scattering structures 34, a deposited polymer coating with light scattering structures 34, etc.). The number of stacked layers L and therefore the density of light scattering structures 34 in each parallel strip-shaped region 42ST of layer 42F increases as a function of increasing lateral distance X across light guide 42. Layers L may be polymer films that are attached to a light guide substrate using adhesive and/or layers L may be applied as coatings to the surface of a light guide substrate layer using printing techniques, spraying techniques, and/or other deposition techniques.

Arrangements of the type shown in FIGS. 16 and 17 and the other FIGS. in which the density of light scattering structures 34 increases as a function of distance from light source 30 may be used to help create evenly extracted light in light guides that are illuminated by a light source located along a single edge of light guide 42 and/or along multiple opposing light guide edges. For example, there may be right and left light sources 30 that supply light to opposing left and right edges of light guide 42. In this type of configuration, light scattering structures in light guide 42 may be provided with a density that increases towards the center of light guide 42 at increasing distances, respectively, from the left and right edges of light guide. If desired, haze compensation layers and other structures for window 16 may likewise be arranged to accommodate configurations in which light guide 42 is edge lit from opposing edges.

In accordance with an embodiment, a system is provided that includes a body, and a window in the body that separates an exterior region from an interior region, the window includes an outer window layer, a light source, and a light guide overlapped by the outer window layer, the light guide is configured to receive light from the light source and the light guide has light scattering structures with a density that increases as a function of increasing distance from the light source.

In accordance with another embodiment, the light guide includes a light guide substrate with a refractive index value, the window includes first and second cladding layers on opposing surfaces of the light guide substrate, the first and second cladding layers have refractive index values lower than the refractive index value of the light guide substrate, a transparent cover layer, the first cladding layer is between the light guide substrate and the outer window layer and the second cladding layer is between the transparent cover layer and the light guide substrate, and an adjustable light modulator between the outer window layer and the first cladding layer.

In accordance with another embodiment, the outer window layer includes laminated window glass.

In accordance with another embodiment, the window includes a haze compensation layer between the light guide and the outer window layer, the haze compensation layer has light scattering structures with a density that decreases as a function of increasing distance from the light source.

In accordance with another embodiment, the density of the light scattering structures in the haze compensation layer is complementary to the density of the light scattering structures in the light guide to create uniform window haze across the window.

In accordance with another embodiment, the system includes an adjustable light modulator between the light guide and the outer window layer.

In accordance with another embodiment, the light scattering structures are configured to extract the received light to supply interior illumination for the interior region, the adjustable light modulator is operable in an opaque state to prevent light from the light guide from passing to the exterior region from the light guide when the interior illumination is being supplied to the interior region.

In accordance with another embodiment, the window includes a haze compensation layer that overlaps the light guide and that has light scattering structures with a density that decreases as a function of increasing distance from the light source.

In accordance with another embodiment, the window includes a cover layer between the light guide and the interior region.

In accordance with another embodiment, the light guide includes a transparent polymer layer and the light scattering structures are embedded in the transparent polymer layer.

In accordance with another embodiment, the light guide includes a light guide substrate, and a light extraction layer on a surface of the light guide substrate, the light scattering structures are formed in the light extraction layer.

In accordance with another embodiment, the light extraction layer includes a cured liquid adhesive coating layer on the light guide substrate.

In accordance with another embodiment, the light extraction layer includes a polymer film attached to the light guide substrate with adhesive.

In accordance with another embodiment, the light scattering structures of the light extraction layer have a density that exhibits stepwise changes as a function of distance from the light source.

In accordance with another embodiment, the body includes a vehicle body.

In accordance with an embodiment, a system is provided that includes a body, and a window in the body that separates an exterior region from an interior region, the window includes an outer window layer, and a light guide illuminator configured to provide illumination to the interior region.

In accordance with another embodiment, the window includes a haze compensation layer between the light guide illuminator and the outer window layer that exhibits a non-uniform haze.

In accordance with another embodiment, the window includes an adjustable optical component layer between the light guide illuminator and the outer window layer.

In accordance with another embodiment, the body includes a vehicle body and the outer window layer includes a laminated glass layer.

In accordance with another embodiment, the light guide illuminator has a light guide layer configured to guide light by total internal reflection and the window includes a glass layer between the light guide layer and the interior region.

In accordance with an embodiment, a system is provided that includes a vehicle body with an interior region, and a window in the vehicle body that separates an exterior region from the interior region, the window has a portion with a curved cross-sectional profile and the window includes a structural window layer facing the exterior region, a light guide illuminator that is overlapped by the structural window layer and that is configured to provide illumination to the interior region, and an adjustable light modulator between the light guide illuminator and the structural window.

In accordance with another embodiment, there are no air gaps between the adjustable light modulator and the light guide illuminator.

In accordance with another embodiment, the light guide illuminator includes a light source that emits light, and a light guide with an edge that receives the emitted light and that has a density of light scattering structures that increases as a function of increasing distance from the light source.

In accordance with another embodiment, the window includes a haze compensation layer having a density of light scattering structures that decreases as a function of distance from the light source.

The foregoing is merely illustrative and various modifications can be made to the described embodiments. The foregoing embodiments may be implemented individually or in any combination.

What is claimed is:

1. A system, comprising:
a body; and
a window in the body that separates an exterior region from an interior region, wherein the window comprises:
an outer window layer;
a light source; and
a light guide overlapped by the outer window layer, wherein the light guide is configured to receive light from the light source and wherein the light guide has light scattering structures with a density that increases as a function of increasing distance from the light source.

2. The system defined in claim 1 wherein the light guide comprises a light guide substrate with a refractive index value, the window further comprising:
first and second cladding layers on opposing surfaces of the light guide substrate, wherein the first and second cladding layers have refractive index values lower than the refractive index value of the light guide substrate;
a transparent cover layer, wherein the first cladding layer is between the light guide substrate and the outer window layer and wherein the second cladding layer is between the transparent cover layer and the light guide substrate; and
an adjustable light modulator between the outer window layer and the first cladding layer.

3. The system defined in claim 2 wherein the outer window layer comprises laminated window glass.

4. The system defined in claim 3 wherein the window further comprises a haze compensation layer between the light guide and the outer window layer, wherein the haze compensation layer has light scattering structures with a density that decreases as a function of increasing distance from the light source.

5. The system defined in claim 4 wherein the density of the light scattering structures in the haze compensation layer is complementary to the density of the light scattering structures in the light guide to create uniform window haze across the window.

6. The system defined in claim 1 further comprising an adjustable light modulator between the light guide and the outer window layer.

7. The system defined in claim 6 wherein the light scattering structures are configured to extract the received light to supply interior illumination for the interior region, wherein the adjustable light modulator is operable in an opaque state to prevent light from the light guide from passing to the exterior region from the light guide when the interior illumination is being supplied to the interior region.

8. The system defined in claim 1 wherein the window further comprises a haze compensation layer that overlaps the light guide and that has light scattering structures with a density that decreases as a function of increasing distance from the light source.

9. The system defined in claim 1 wherein the window further comprises a cover layer between the light guide and the interior region.

10. The system defined in claim 1 wherein the light guide comprises a transparent polymer layer and wherein the light scattering structures are embedded in the transparent polymer layer.

11. The system defined in claim 1 wherein the light guide comprises:
a light guide substrate; and
a light extraction layer on a surface of the light guide substrate, wherein the light scattering structures are formed in the light extraction layer.

12. The system defined in claim 11 wherein the light extraction layer comprises a cured liquid adhesive coating layer on the light guide substrate.

13. The system defined in claim 11 wherein the light extraction layer comprises a polymer film attached to the light guide substrate with adhesive.

14. The system defined in claim 11 wherein the light scattering structures of the light extraction layer have a density that exhibits stepwise changes as a function of distance from the light source.

15. The system defined in claim 1 wherein the body comprises a vehicle body.

16. A system, comprising:
a body; and
a window in the body that separates an exterior region from an interior region, wherein the window comprises:
an outer window layer; and
a light guide illuminator configured to provide illumination to the interior region.

17. The system defined in claim 16 wherein the window further comprises a haze compensation layer between the light guide illuminator and the outer window layer that exhibits a non-uniform haze.

18. The system defined in claim 16 wherein the window further comprises an adjustable optical component layer between the light guide illuminator and the outer window layer.

19. The system defined in claim 16 wherein the body comprises a vehicle body and wherein the outer window layer comprises a laminated glass layer.

20. The system defined in claim 16 wherein the light guide illuminator has a light guide layer configured to guide light by total internal reflection and wherein the window further comprises a glass layer between the light guide layer and the interior region.

21. A system, comprising:
a vehicle body with an interior region; and
a window in the vehicle body that separates an exterior region from the interior region, wherein the window has a portion with a curved cross-sectional profile and wherein the window comprises:
a structural window layer facing the exterior region;
a light guide illuminator that is overlapped by the structural window layer and that is configured to provide illumination to the interior region; and
an adjustable light modulator between the light guide illuminator and the structural window.

22. The system defined in claim 21 wherein there are no air gaps between the adjustable light modulator and the light guide illuminator.

23. The system defined in claim 21 wherein the light guide illuminator comprises:
a light source that emits light; and
a light guide with an edge that receives the emitted light and that has a density of light scattering structures that increases as a function of increasing distance from the light source.

24. The system defined in claim 23 wherein the window further comprises a haze compensation layer having a density of light scattering structures that decreases as a function of distance from the light source.
